(19) United States
(12) Patent Application Publication
(10) Pub. No.: US 2007/0169028 A1
(43) Pub. Date: Jul. 19, 2007

(54) Partitioning of non-volatile memories for vectorization

(76) Inventors: Glenn Kasten, San Mateo, CA (US); Richard Michael Powell, Mountain View, CA (US); Ravi Tatavarthi, Sunnyvale, CA (US)

Correspondence Address: James C. Scheller;BLAKELY, SOKOLOFF, TAYLOR & ZAFMAN LLP, Seventh Floor, 12400 Wilshire Boulevard, Los Angeles, CA, 90025, US

(21) Appl. No.: 11/303,675

(22) Filed: Dec. 15, 2005

(51) Int. Cl. G06F 9/45

(52) U.S. Cl. 717/140

(57) ABSTRACT

Methods, Software products and systems for Partitioning of Non-Volatile Memories for Vectorization may include analysis, partitioning, building, and optionally, verifying and iterating.

### FIELD OF THE INVENTION

The present invention relates generally to the field of application-specific electronic devices that include finite state automata. More particularly, this invention relates to apparatus, systems and methods for storage of fixed or rarely changing digital data tables and/or related instruction codes.

### BACKGROUND

Usage of application-specific electronic devices that include finite state automata is commonplace. In the never-ending search for price/performance improvement and associated commercially advantageous feature offerings, many aspects of devices are optimized. Multiple memory technologies are available each with associated tradeoffs. Optimal exploitation of memory devices is thus desirable. Especially wherever multiple memory technologies are used in a particular device, but even where not, such optimization is non-trivial and there is always scope for improvement.

Memory technologies may include ROM (read-only memory), SRAM (Static random-access memory), DRAM (Dynamic RAM), EEPROM (Electrically-Erasable Programmable Read-Only Memory), FLASH (a fast block-oriented type of EEPROM) and more.

It may be desirable to place executable code in any or all of the types of memory available in a target device. Placing firmware in ROM presents well-known challenges in regards to making revisions after a device has been manufactured.

One problem with storing code in ROM is that it is static and cannot be corrected (absent physically replacing and re-writing the ROM). Accordingly, making changes to instruction codes or data can be problematic. One approach is the use of memory vectors (usually in arrays or tables) for calls or jumps to provide hooks for patches. There are performance overhead tradeoffs and prescience may be needed (if not always fulfilled) to anticipate good placement of patch hooks. “Patch” is a term of art which refers to new instruction code (or sometimes data) introduced to remedy prior code and/or to add or revise functionality. A patch hook is a preinstalled space for creating a patch. A memory vector causes a jump or call to a location in a different memory block where the patch code may reside.

Another approach is through the use of so-called “tail patches” wherein patch hooks are associated with routines' exit points rather than entry points.

### SUMMARY

Embodiments of this invention may include Methods, Software products and/or systems for the partitioning of memories (which may be non-volatile memories) especially to facilitate vectorization including analysis, partitioning, building. Verifying and iterating may also be included in some embodiments. Embodiments of the invention may operate on source code and on object code and may sometimes include actual and/or simulated execution especially to verify memory sizing and execution speed.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

In the drawings:

FIG. 1 shows a representation of memory blocks according to an embodiment of the invention.

FIG. 2 shows a representation of a method according to an embodiment of the invention.

FIG. 3 shows a representation of a method according to an embodiment of the invention.

FIG. 4 shows a representation of a method according to an embodiment of the invention.

FIG. 5 shows a representation of a method according to an embodiment of the invention.

FIG. 6 shows an example for the C language of vectorizing a file

FIG. 7 shows an exemplary Vector Table Generator such as may be used to embody a Vectorization process according to an embodiment of the invention.

FIG. 8 shows an exemplary Heuristic Partitioning method according to an embodiment of the invention.

### DETAILED DESCRIPTION

In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

A computer program may comprise a set of functions (sometimes termed “routines”) and constant data. These may be expressed as source code in a computer programming language such as C language. The functions and constant data may be translated into object code (binary data images of memory) such as by a compiler, linker etc. and may be placed into memory for execution by a computer processor, microcontroller, finite-state automata, apparatus or other machines such as may be controlled by programmed code that may be recorded on readable media such as magnetic disks.

A computing system may have various kinds of memory technology available such as ROM, Flash, RAM, etc. Each type of memory technology may have a different speed, cost, and other characteristics such as word-width, latency, read and write cycle times etc. For example ROM is typically faster, lower-cost, and requires less power than Flash or RAM, but has the characteristic that it is read-only which can be both advantageous and disadvantageous. Thus, depending on the application, it may be impossible or costly to correct defects, alter behavior, or add functionality to code in ROM by replacing an entire ROM.

The read-only characteristic of ROM can also be seen as an advantage as it can improve system security from computer viruses, worms, and other threats. ROM may also be a more reliable technology due to its greater simplicity and/or other reasons. Because of the many advantages of ROM, it can be beneficial to use ROM while overcoming its chief limitation, the difficulty of selective instruction code (and/or constant data) updates.

There are various techniques for allowing ROM functions be effectively modified or replaced on an individual basis. For an example U.S. Pat. No. 5,546,586 apparently discloses a “Method and Apparatus for Vectorizing the Contents of a Read Only Memory Device Without Modifying Underlying Source Code”. The term vectorizing may mean replacing direct function calls by indirect function calls, for example through a vector table in read/write memory.

However, vectorization may produce larger and slower executing code. Indirect jumps may use more memory and CPU (Central Processing Unit) time than direct jumps because they typically require a fetch from a vector table entry (which may be in RAM), and require longer or additional instructions to do the jump. Therefore it is advantageous to use vectorization only when justified. For example, a closed set of related small functions that call only each other could use direct function calls, and potentially be updated as a block rather than individually.

Computer language compilers may offer various code generation options, such as optimizing for time (reduced CPU execution time) or optimizing for space (reduced code size). Some CPUs have different sized instructions that offer a choice between smaller code size and faster execution. For example, the ARM™ (Advanced RISC Machines Ltd) processor family that is popular in many embedded and real-time applications has a choice of 32-bit (“ARM”) or 16-bit (“Thumb”) instructions. A compiler option may select which one to deploy.

For various reasons, designers sometimes use a mix of compilers, linkers, and other software development tools provided by different vendors. These tools often use different and incompatible object file formats and calling conventions. Although not critical to embodiments of the invention, a further benefit of vectorization is that it provides an appropriate point in the system architecture to insert “stubs” or “thunks” which may handle interface and/or translation such as between variants of object file formats and calling conventions etc.

System designers may choose a mixture of differing memory technologies in order to meet overall system requirements. Inter alia, for each memory technology, the designer may have a budget or desired maximum size (such as a number of available kbytes (kilobytes)).

Designs may also have a particular required minimum level of system performance. For applications requiring real-time operation and predictable response times, meeting the system performance goals may typically be critical. For example, in audio applications, a failure to achieve the required performance could result in stuttering, gaps, repeated sounds, clicks, noise, and other unacceptable and/or undesirable behavior or effects. In particular, the invention described here was used in a chipset for mobile phone devices to order to ensure that the audio algorithms responsible for “ringing” the phone performed to expectations; without use of the disclosed embodiments using ringtone content within specifications could exhaust the available CPU performance on the device, resulting in a phone that fails to ring when required and/or drops phone calls etc. Thus, use of embodiments of the invention can permit audio sounds to be played without the “choppiness” that may be found in previously developed solutions of similar audio recordings product.

Achieving a required (or desired) system performance within available memory budgets, while allowing for future code updates, requires a balanced solution that may be difficult to achieve in practice. Many previously developed solutions have been overly reliant on hand-crafted optimizations.

It can be advantageous to put the most performance-critical functions (those wherein the most CPU time is spent, or those which need a fast and predictable response time —such as interrupt handlers) into the fastest type of memory available. It may also be advantageous to assign the functions that are most stable (least likely to need changes) and/or most sensitive to security and reliability concerns into read-only memory. And functions assigned to ROM must be selectively updateable yet the memory and performance cost of vectorization must be constrained. Embodiments of the invention may provide a method for solving this complex problem, and more.

A designer may specify the maximum amount of memory available for each memory technology (the budget), and the maximum size of each block per technology. For example, the designer might specify that there is total of 20 kbytes of ROM available and that no ROM block may be larger than 2 kbytes. An exemplary maximum block size of 2 kbytes (2048 bytes) could imply that replacement (or patching) of any selected function could require at most 2 kbytes of ROM to be updated such as by using vector replacement.

The designer may also specify overall goals, such as to put the most performance-intensive functions into ROM, with all of the other code is to be assigned to Flash memory.

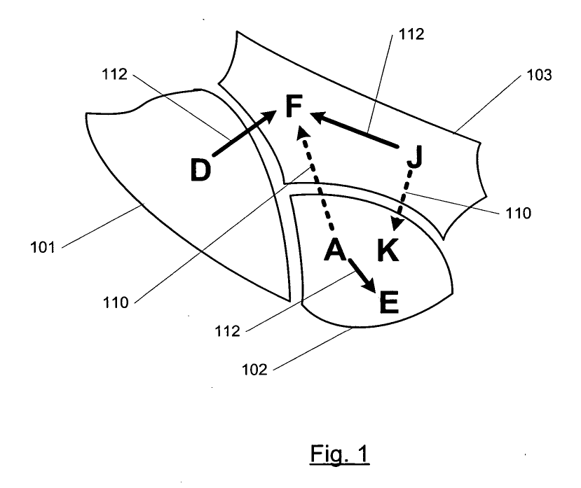

FIG. 1 shows a representation of memory blocks according to an embodiment of the invention. In the exemplary embodiment, two of the blocks 102, 103 of memory are assigned to ROM. A further block 101 is assigned to Flash memory. Practical embodiments of the invention will typically have a great many more than three blocks of memory.

Three blocks of memory are shown: Block 103 contains functions F and J, and is assigned to ROM. Block 102 contains functions A, E, and K, and is also assigned to ROM. Block 101 contains function D, and is assigned to Flash memory.

Solid arrows 112 represent direct function calls, and dashed arrows 110 represent indirect calls via vector table(s).

It may be noted that: Calls from one function to another function in the same block (A calling E, J calling F) are direct 112. Calls from a function in one ROM block to a function in a different block (A calling F, J calling K) are indirect 110.

As an exception, a call from a function in Flash block 101 to a function in a different block (D calling F) is permitted to be direct 112 as there may be little or no advantage to making it indirect. In general, non-volatile Flash memories are readily amenable to in-service changes (remedial changes to the memory content) and therefore there may be no strong incentive to vectorizing access to functions executed out of Flash memory (or indeed for functions executed from RAM).

Embodiments of the invention may accomplish automatic assignment (during a build process) of functions to blocks and replacement of direct calls by indirect calls as needed. Functions within a particular block of ROM memory may be replaced by updating vector table(s). The memory cost for this replacement should always be no more than the maximum respective ROM block size.

Embodiments of the invention may take source code (examples are in C language, but the invention is not limited to C language), and partition it into smaller blocks of source code. Partitioning typically satisfies the following:

A block typically consists of all the functions/routines/procedures that directly call each other (without using vectors), and any associated constant data referenced by these functions. Each block and its associated functions is typically assigned to a single category of memory technology such as ROM, Flash, RAM, etc. based on criteria including performance, cost, likelihood of future change, security, etc. Compilation options are typically also assigned to the block and functions.

Each block may be limited to a pre-determined size specified by a designer for that particular category of memory (for example, a maximum of 2 kbytes per block in ROM)

Any call or jump from a function in one block to a function in another block is to be accomplished indirectly by replacing a direct function call with an indirect function call via a vector table or similar.

As an exception it may be permissible for a function in a block assigned to read/write memory (such as Flash or RAM) to directly call a function in another block, since there may be little no benefit to using a vector for such a call as discussed above.

Every part of the source code is assigned to precisely one block (all the blocks taken together include the entire original source code, and no blocks overlap).

As an exception (which may be expected to be used only rarely), code may be duplicated in multiple blocks if it is advantageous so to do (e.g. a very small function or constant data item might be duplicated in each block within which it is used).

Together these rules can ensure that functions and their constant data are automatically assigned to optimal or near optimal price/performance memory technologies, and that each function may be replaceable at a fixed maximum cost. In particular, it is possible to replace any ROM block by another block, with a predictable cost for the replacement memory.

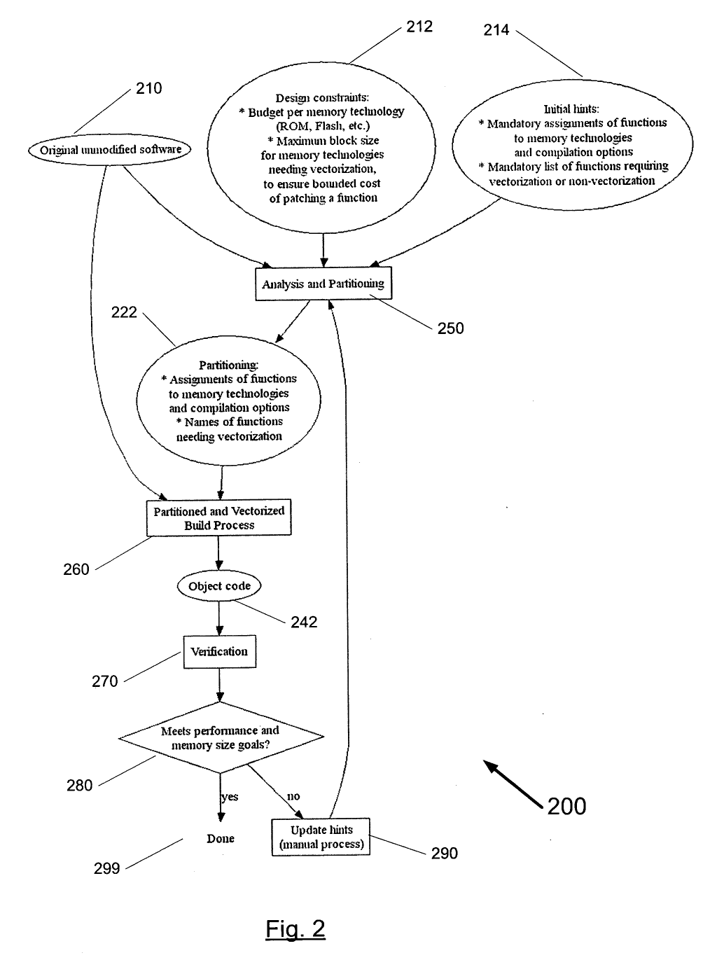

FIG. 2 shows a representation of a method 200 according to an embodiment of the invention. In the figure oval shapes represent information such as datasets and rectangular shapes represent processes which may either typically be embodied as software tools or, in a few cases, performed manually.

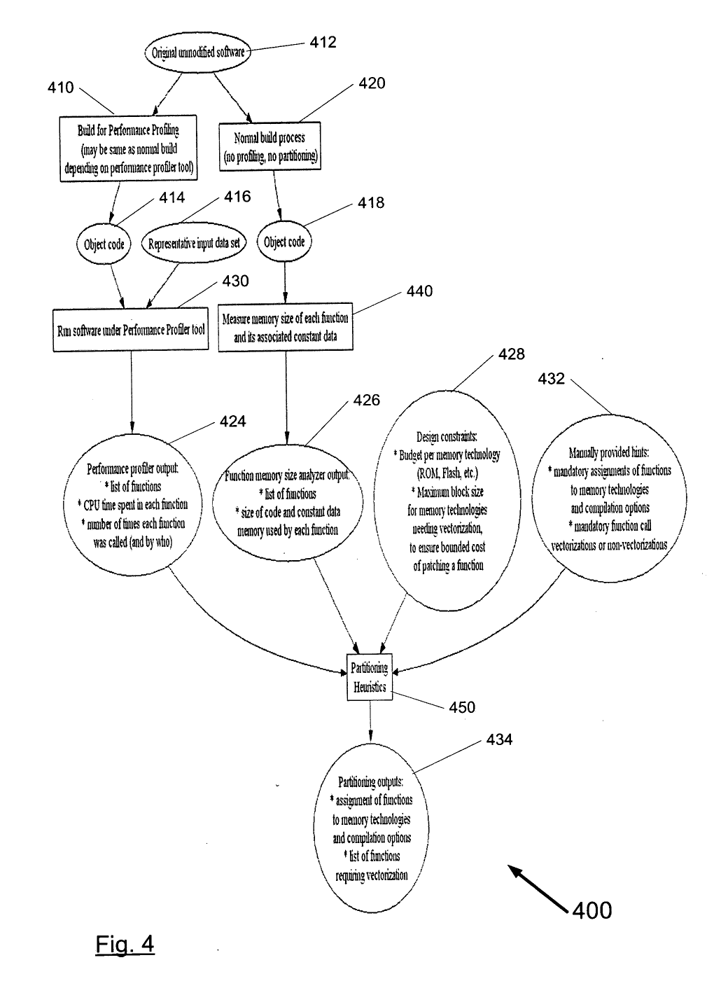

In box 250 Analysis and Partitioning of an input set 210 of Original Unmodified Software (source code) is performed. The Analysis and Partitioning 250 is further described below in connection with FIG. 4. Input information to the Analysis and Partitioning 250 includes Design Constraints 212 and Initial Hints 214. Output information includes partitioning information 222 such as lists of names of functions mapped to memory technologies and whether or not to be vectorized.

Then a Build Process 260 is performed that includes partitioning and vectoring of the functions responsive to the results 222 of the Analysis and Partitioning 250. The Build Process 260 generates Object Code 242.

The Object Code 242 is then Verified 270 for performance and memory size. If the performance and memory size meet the requirements (goals) 280 then the method is completed 299. Otherwise information is generated that permits refinement and Update 290 of the input Hints. This act 290 may be performed as a Manual Process for optimal results.

The process returns to the Analysis and Partitioning 250 to iteratively converge upon satisfactory completion 299.

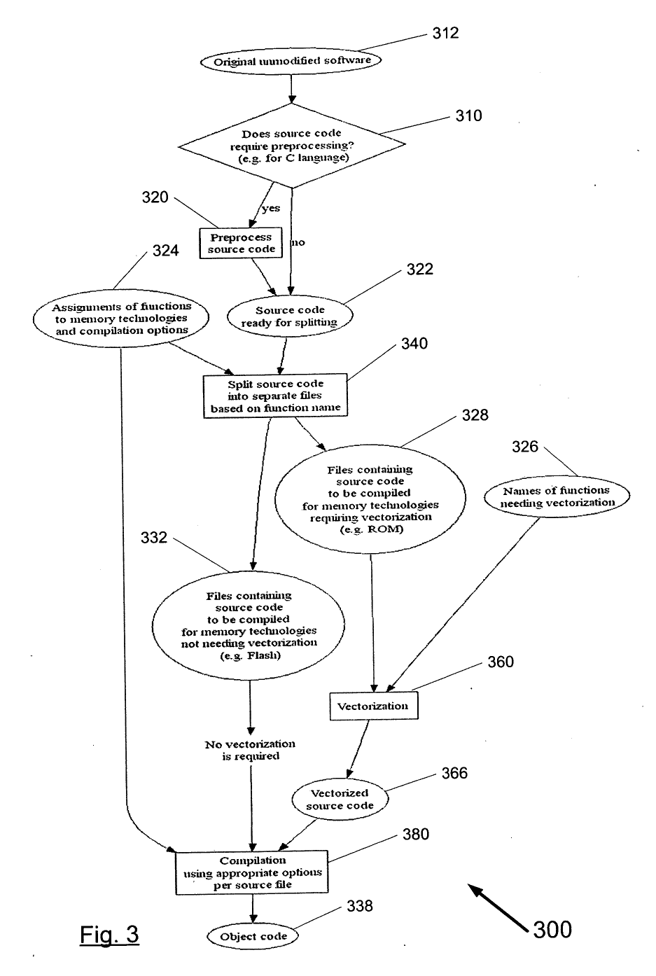

FIG. 3 shows a representation of a method 300 according to an embodiment of the invention. Method 300 is an example of a Build Process such as may be used to implement Partitioned and Vectorized Build Process 260 (FIG. 2, above).

Returning to FIG. 3, starting with the Original Unmodified Software (source code) 312, a determination 310 is made as to whether preprocessing is required. If so the source code is Preprocessed 320 to produce Source Code 322 that is ready for splitting.

As to Pre-processor 320, for languages requiring pre-processing such as C language, pre-processing the source code may include expanding includes, compile-time conditionals, and macros. An example is the GNU gcc program with option “-E” which produces an output file with “.i” extension from a “.c” source file

A further process is for a Code-Splitter 340 to split the source code into separate files based on function name. Inputs to the Code-Splitter 340 may include the Assignment of functions to particular memory technologies 324 such as may have been generated 222 as described above in connection with FIG. 2.

Code-Splitter 340 may use various techniques, such as: Extracts selected functions and data from preprocessed source code. An exemplary Code-Splitter 340 takes as input one or more pre-processed file with “.i” extension, and a list of function names and data names to be included (or functionally equivalent, those to be excluded). The output is a file that contains a subset of the declarations and definitions, as follows:
function definitions specified to be included (or equivalently, not excluded) are copied to the output
data definitions specified to be included (or equivalently, not excluded) are copied to the output
declarations of items that have no visible effect on memory are always copied to the output; these include enumeration constant, structure declarations, type declarations, and function/data declarations (as opposed to definitions)

Code Splitter 340 may operate by searching through the input text for a pattern resembling the syntax of a function, data, enumeration constant, structure, and type declarations and definitions. For each declaration and definition found, it either copies it to the output or discards the text, based on the rules given above. To facilitate debugging, line numbers are preserved and kept in synchronization with the original source code by substituting a blank line in the output for any line in the input that is not to be copied, and/or by using the C “#line” directive.

Still referring to FIG. 3, outputs from the Code Splitter 340 may include Files 332 containing source code to be compiled without vectorization and Files 328 containing source code to be compiled with vectorization. For example, in an embodiment of the invention, source code to be compiled without vectorization 332 is destined for embodiment in Flash memory and Source Code to be compiled with vectorization 328 is destined for embodiment in ROM.

A further process is a Vectorization 360 of the Source Code to be compiled with vectorization 328. Input includes a list 326 of Names of functions needing vectorization such as may have been generated 222 as described above in connection with FIG. 2.

The Vectorization process 360 may generate Vectorized Source Code 366 which is part of the input to a Compilation Process 380 that is reliant on using the appropriate options for each source file that have been generated by the processes described above. Output includes Object Code 338.

FIG. 4 shows a representation of a method 400 according to an embodiment of the invention. Method 400 is an example of an Analysis and Partitioning Process such as may be used to implement Analysis and Partitioning Process 250 (FIG. 2, above).

Returning to FIG. 4, starting with the Original Unmodified Software (source code) 412, a Normal (conventional) Build 420 is made to produce Object Code 418. Also, a Build 410 for Performance Profiling is made to generate respective Object Code 414. In some embodiments Builds 410, 420 may be the same (depending on the availability and characteristics of the selected software performance profiling tool).

A representative input dataset 416 may be input together with Object Code 414 to a Run under a Performance Profiler Tool 430.

Performance Profiler 430 may provide various features such as: measuring time spent in each function for a representative execution, counting function calls and what calls each fuinction, and typically producing a dynamic function call graph. Performance Profiler 430 may generate output 424 that includes such things as: for each of a list of functions, the amount of CPU (Central Processing Unit) time spent in each function (or, equivalently, clock cycle counts) and the number of times each function is called and by which functions.

After a Normal Build 420, Object Code 418 may be input to a Function Size Analyzer 440 that estimates the memory size of each function and its associated constant data. It is possible to do this in both a “coarse” and “fine” way. The “coarse” method gives a rough estimate that is typically accurate enough. It operates by computing the size of a given function as the address of the next function (in ascending address order) minus the address of the given function. An example of the coarse method is the GNU utility program nm with—numeric-sort or -size-sort options. The “fine” method is a more sophisticated method that may give a better quality estimate but requires a static control flow graph. It may operate by starting at the function entry point, and recursively traversing the static control flow graph including constant data references, summing the sizes of each basic block and constant data found. Alternative, but substantially comparable, approaches are possible too.

A Static call graph analyzer may be software that produces a static function call graph. An example is the ARM Ltd. utility armlink with option—callgraph which outputs an HTML file showing the static call graph. Function Size Analyzer 440 produces output 426 that may include a list of functions and for each respective function the size of the codespace and constant data memory used by that function.

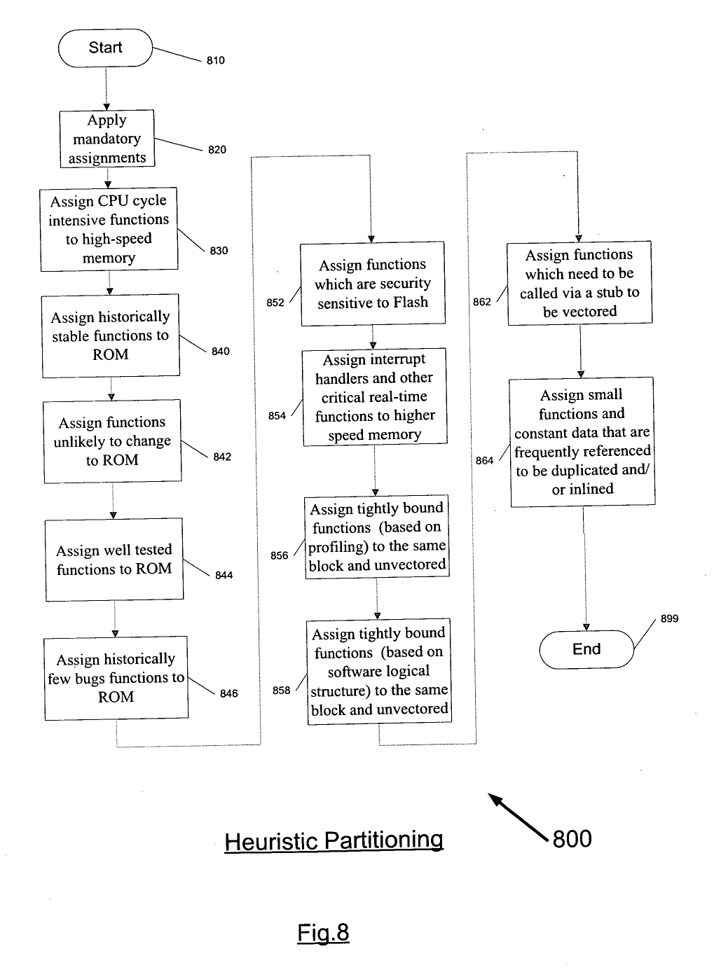

A Partitioning Heuristics process 450 may take several inputs. These may include Performance Profiler 430 output 424, the Function Size Analyzer 440 output 426, a set of design constraints 428 and a set of hints 432 to provide criteria for the Partitioning Heuristics process 450. In some embodiments the set of hints 432 may be generated by a manual (intelligent) process. An exemplary Partitioning Heuristics process 450 is described in further detail below in connection with FIG. 8.

Still referring to FIG. 4, output 434 from the Partitioning Heuristics process 450 may include an assignment of functions to respective memory technologies together with compilation options and a list of functions requiring vectorization.

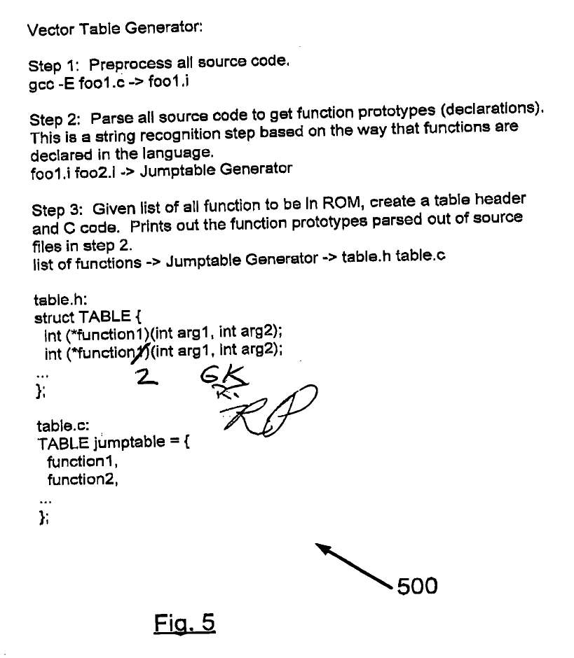

FIG. 5 shows a representation of a method 500 according to an embodiment of the invention. Method 500 is an example of a Vectorization Process such as may be used to implement Vectorization process 360 (FIG. 3, above).

As shown, Vectorization Process 500 may include several steps such as: Step 1: Preprocess all source code. Step 2: Parse all source code to get function prototypes (declarations). Step 2 may be a string recognition step based on the way that functions are declared in the language. Step 3: given a list of functions to be in ROM, create a table header and C code. Step 3 may also print out function prototypes parsed out of source files in step 2.

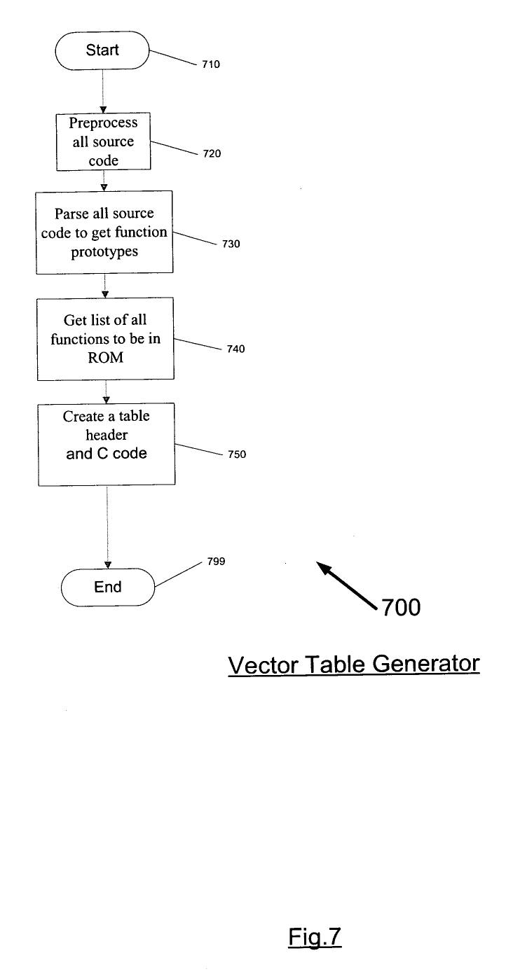

FIG. 7 shows an exemplary Vector Table Generator 700 such as may be used to embody the Vectorization process 360 of FIG. 3.

Vector Table Generator 700 (sometimes called Jump Table Inserter or Vectorizer) may be a tool that converts C-Code from calling specified functions directly to utilizing indirect function pointer references located in a Vector Table (sometimes called a Jump Table).

After Starting 710, Vector Table Generator 700 may Preprocess all source code 720 then it may Parse 730 all source code to get function prototypes. Next, at box 740 it may get a list of all functions to be in ROM. In box 750, a table header and related C code may be created and the Generator is completed 799.

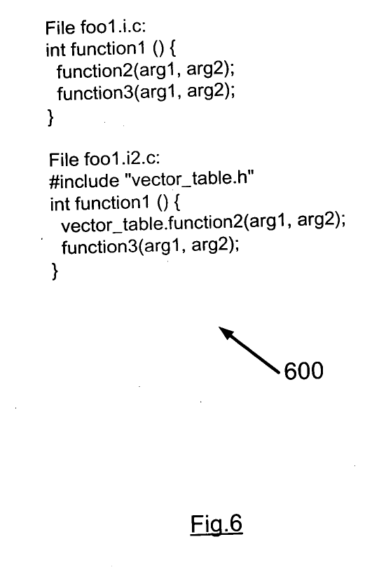

FIG. 6 shows an example 600 for the C language of vectorizing a file fool.i.c into fool.i2.c:

In the example 600, calls to function “function2” are vectorized, but calls to function3 are not vectorized. The choice is based on an input to the Vectorizer that specifies this. The exemplary Vectorizer 600 may make this transformation by searching through the input text for a pattern that resembles the syntax of a function call, then checking to see whether the function name matches one needing vectorization, and if so replacing the direct function call by indirect function call.

FIG. 8 shows an exemplary Heuristic Partitioning method 800 according to an embodiment of the invention. It will be appreciated that many alternative Heuristic Partitioning methods are feasible within the general scope of the invention and no particular order, sequencing or set of features is in any way critical.

In box 810, the method Starts. In box 820, mandatory assignments may be applied. In box 830, CPU cycle intensive functions may be assigned to high-speed memory

In box 840, historically stable functions may be assigned to ROM. In box 842, functions unlikely to change may be assigned to ROM. In box 844 well-tested functions may be assigned to ROM. In box 846, functions with historically few bugs may be assigned to ROM.

In box 852, functions which are security sensitive may be assigned to Flash. In box 854, interrupt handlers and other critical real-time functions may be assigned to higher speed memories.

In box 856, tightly bound functions (based on profiling) may be assigned to the same block and unvectored. In box 858, tightly bound functions (based on software logical structure) may be assigned to the same block and unvectored

In box 862, functions which need to be called via a stub may be assigned to be vectored. In box 864, small functions and constant data that are frequently referenced may be assigned to be duplicated and/or inlined. At box 899, the process ends.

As is well-known in the art, data processing methods may be incorporated into conventional systems using various combinations of electronic circuitry, or programmed instructions such as software or firmware that may be embodied on machine readable media and executed by finite state automata such as general purpose computers, embedded microcomputers or ASIC (Application Specific Integrated Circuits). Such media and apparatus may fall within the general scope of the invention.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense. In particular, the disclosure of methods does not necessarily imply any particular order or sequence in which the various acts and/or steps are executed.

What is claimed is:

1. A method for partitioning of memories comprising:
creating a predetermined set of performance criteria;
analyzing a source file for a list of functions;
building first executable code from the source file;
performance profiling the first executable code for each function in the list of functions;
measuring the memory occupancy of each function in the list of functions;
assigning functions to a plurality of memory technologies according to at least one heuristic that inputs at least one set of results from the performance profiling and that inputs at least one set of results from the measuring and
building a second executable code comprising a vector table responsive to the assigning.

2. The method of claim 1, wherein:
the memory technologies are non-volatile memory technologies.

3. The method of claim 1, further comprising:
verifying that the second executable code meets the performance criteria.

4. The method of claim 3, wherein:
the performance criteria comprise maximum memory sizes.

5. The method of claim 3, wherein:
the performance criteria comprise maximum execution times or maximum cycle counts.

6. The method of claim 1, wherein:
the vector table is a vectored call table.

7. The method of claim 1, wherein:
the vector table is a vectored jump table.

8. The method of claim 1, wherein:
the plurality of memory technologies comprises RAM (random access memory), ROM (Read-only memory) and either EEPROM (Electrically Erasable Programmable Read-Only memory) or Flash memory (Flash EEPROM memory).

9. A machine readable storage medium that stores instructions, which when executed by the machine to cause the machine to perform the acts of:
analyzing a source file for a list of functions;
building first executable code from the source file;
performance profiling the first executable code for each function in the list of functions;
measuring the memory occupancy of each function in the list of functions;
assigning functions to a plurality of memory technologies according to at least one heuristic that uses as input at least one set of results from the performance profiling, further according to at least one set of results from the measuring and still further according to a predetermined set of performance criteria and
building a second executable code comprising a vector table responsive to the assigning.

10. The medium of claim 9 wherein:
the memory technologies are non-volatile memory technologies.

11. The medium of claim 9 wherein the acts further comprise:
verifying that the second executable code meets the performance criteria.

12. The medium of claim 9 wherein:
the performance criteria comprise maximum memory sizes.

13. The medium of claim 9 wherein:
the performance criteria comprise maximum execution times or maximum cycle counts.

14. The medium of claim 9 wherein:
the vector table is a vectored call table.

15. The medium of claim 9 wherein:
the vector table is a vectored jump table.

16. The medium of claim 9 wherein:
the plurality of memory technologies comprises RAM (random access memory), ROM (Read-only memory) and either EEPROM (Electrically Erasable Programmable Read-Only memory) or Flash memory (Flash EEPROM memory).

17. An apparatus comprising:
a ROM (Read-Only Memory) and
a Flash memory;
wherein the ROM and the Flash memory jointly contain a copy of object code formed by executing programmed instructions on a finite-state automaton to cause the automaton to perform the acts of:
analyzing a source file for a list of functions;
building first executable code from the source file;
performance profiling the first executable code for each function in the list of functions;
measuring the memory occupancy of each function in the list of functions;
assigning functions to a plurality of memory technologies according to at least one heuristic that inputs at least one set of results from the performance profiling, to at least one set of results from the measuring and to a predetermined set of performance criteria and
building a second executable code comprising a vector table responsive to the assigning.

18. The apparatus of claim 17, wherein:
the acts further comprise verifying that the second executable code meets the performance criteria.
